(19) United States
(12) Patent Application Publication
(10) Pub. No.: US 2003/0070525 A1
(43) Pub. Date: Apr. 17, 2003

(54) Meat slicer device

(76) Inventor: Everett E. Barnhart, Leawood, KS (US)

Correspondence Address: POLSINELLI SHALTON & WELTE, P.C., 700 W. 47TH STREET, SUITE 1000, KANSAS CITY, MO, 64112-1802, US

(21) Appl. No.: 09/977,020

(22) Filed: Oct. 12, 2001

(51) Int. Cl. B26D 1/18

(52) U.S. Cl. 83/932; 83/483

(57) ABSTRACT

The present invention relates to a meat-slicing device comprised of a control system, knife assembly, a mast assembly, a unitary cabinet, and a rotation assembly.

### FIELD OF INVENTION

The present invention relates to a device for slicing meat products, wherein the device is designed to be comparatively sanitary and can cut bone-in and boneless meat products. The device includes a unitary cabinet, a sealed knife assembly, an assembly for rotating the meat product, and an assembly for moving the knife assembly both vertically and horizontally.

### BACKGROUND OF INVENTION

Devices for slicing meat products, such as a ham, roast beef, or turkey, have been well known. Such devices are used in both limited production and high production industrial settings, where potentially thousands of meat products are packaged and shipped daily. Rapid meat slicing devices are now used in the industrial meat industry to produce pre-sliced hams and turkeys for consumers. Such pre-sliced products include bone-in and boneless products.

Because these types of devices are often used in industrial settings, sanitation and safety are important concerns. Many meat-slicing devices have various crevices and exposed parts, which are difficult to clean. As such, small bits of meat and blood are found on such parts and in such crevices, and are ideal for allowing the proliferation of microorganisms. For this reason, it is desired to have a device that can be easily cleaned and does not readily house or retain small pieces of cut meat and blood. In particular, it is desired to have a device that complies with the sanitary standards promulgated by various government agencies.

Another concern involves the ability to safely use the known devices. It is not unusual for workers using such machines to expose their fingers or hands to the cutting blades, resulting in serious injury. Many known devices have an open construction that allows for easy access to the knife or blade before, during, and after cutting. Thus, it is desired to have a device that prevents a worker from easily exposing his or her digits or limbs to the cutting blade of the device. It is especially desired to have a device that cannot be activated while a worker is in a position to expose his or her limbs to the blade.

Another issue associated with an industrial cutting device is whether such device can be used for bone-in or boneless products. When cutting a bone-in product, it is desired for the cutting blade to only lightly contact the bone. If the blade contacts the bone with too much force, bone chips will result. Commercial meat products are generally undesirable if there are loose bone chips. Thus, it is desired to have a system that allows the blade to contact the bone to reduce chipping the bone. Additionally, it is desired to have a device that can cut a boneless product and form a meat core so that the shape of the bulbous meat product may be retained.

Typically, these meat-cutting devices are used in an industrial setting. It is necessary for such devices to have a construction that prevents or limits breakdowns. One way this can be achieved is by limiting the number of exposed parts. Thus, it is desired to have a device that can be subjected to increased wear and tear, without readily breaking down. It is further desired to have a device that does not have numerous exposed parts.

It is further desired to have a device that can precisely cut the meat products. In particular, it is desired to have a device that can have the desired dimensions input, and that can precisely cut the meat product to such desired dimensions.

As such, it is desired to have a device for cutting meat products that can be easily cleaned so that it is a sanitary device. It is further desired to have a device that has enhanced safety features to protect workers from injury. This is especially true, since it is desired to have a device that can be used in an industrial setting. Finally, it is desired to have a device that can cut bone-in and boneless meat products.

### SUMMARY OF INVENTION

The present invention relates to a meat slicer for use in cutting or slicing meat products. The present device is designed so that a limited number of parts are exposed. In particular, most of the assemblies that form the present device are housed in a cabinet member, which is advantageous because the present device protects those parts that might be readily damaged during operation. Those parts or assemblies that are not housed in the cabinet are covered so that parts are not readily exposed. For example, the knife assembly housing covers the various parts of the knife assembly. As such, the present invention is of a more rugged construction, and, as a result, is well suited for use in an industrial setting.

A cabinet member for housing most of the components of the assemblies that form the present device is part of the construction. The cabinet is of a unitary construction, except for having at least one door which allows for access to the components housed therein, and at least two holes which allow for a portion of the assembly to pass through the cabinet and be located on the surface thereon. When an assembly passes through a hole, a sealed connection is formed. As a result of the unitary construction and the sealed relationship, the present device can be easily cleaned and does not readily harbor microorganisms. This is advantageous because it contributes to the comparatively sanitary nature of the present device in view of other known devices. The present device is especially advantageous because it can be cleaned in such a way that it more readily complies with the sanitary standards promulgated by most government organizations.

The present invention is further designed such that it is comparatively safer to use than most other known meat slicing devices. In particular, a number of features are included in the present device, which help protect operators from exposing their digits to the knife assembly before and during operation. A shroud is located on top of the cabinet and substantially prevents access to the knife

The unitary cabinet member houses a portion of a mast assembly and a rotation assembly. The mast assembly is attached to a knife assembly, which, when moved into position, will cut the meat product. The mast assembly is primarily housed in the cabinet, and is used to move the knife assembly both vertically and horizontally. Additionally, the mast assembly is designed to allow the knife to cut both bone-in and boneless meat products. The mast assembly is any of a variety of devices and constructions that can be housed in the cabinet and can cause the movement of the knife horizontally and vertically. The mast system described herein is especially preferred because it allows for precision cutting of the meat product.

The knife assembly is located on top of the mast system and above the cabinet member, with most of the components of the knife assembly located in a housing member. The knife can be actuated so that it has a reciprocating motion during cutting. Any knife member, however, may be used, so long as slicing or cutting can be precisely controlled so as to ensure a predetermined slice thickness. Instead of a knife, a circular blade, for example, can be used.

The meat product is placed on a rotation assembly, which will synchronously rotate the meat product from both the top and bottom. This is important to ensure even and accurate cutting of the meat product. The rotation assembly will work in conjunction with the microprocessor, knife and mast assemblies to ensure accurate and controlled cutting of the meat product. Specifically, the present system allows for an operator to digitally enter the rotation speed of the rotation assembly, as well as a cut thickness to three decimal places, and a maximum cut height. The cut height is the final distance between the knife and the spikes of the rotation assembly in the top of the meat product. The operator will also have control of a function key interface to allow for visual control over the maximum cut depth. As such, the present invention is advantageous because precise cutting of the meat product can occur.

Thus, the present invention is advantageous because it is sanitary, safe, precise, and durable. It is believed that this combination of advantages distinguishes the present invention from known inventions.

### BRIEF DESCRIPTION OF DRAWINGS

FIG. 1 is a front perspective view of the device of the present invention;

FIG. 2 is a top plan view of the device of the present invention;

FIG. 3 is a side perspective cutaway view of the device of the present invention;

FIG. 4 is a front perspective cutaway view of the device of the present invention;

FIG. 5 is an exploded side cutaway view of the mast system and knife assembly;

FIG. 6 is an exploded front cutaway view of the mast system moving in a vertical plane;

FIG. 7 is an exploded front cutaway view of the rotation assembly;

FIG. 8 is an exploded side cutaway view of the mast system and bottom plate;

FIG. 9 is a top plan view of the bottom plate;

FIG. 10 is an exploded front cutaway view of the bottom plate;

FIG. 11 is an isolated view of the mast tube attached to the top plate;

FIG. 12 is a top plan view of the top plate, mast tube, and hex head tube;

FIG. 13 is a top plan view of the actuating arm;

FIG. 14 is a side view of the actuating arm;

FIG. 15 is an isolated side view of the tail stock;

FIG. 16 is an isolated side view of the turntable;

FIG. 17 is a top plan view of the turntable;

FIG. 18 is a top plan view of the knife assembly being inserted into a boneless meat product held by the turntable; and,

FIG. 19 is a top plan view of the knife assembly being inserted into a bone-in meat product held by the turntable.

### DETAILED DESCRIPTION

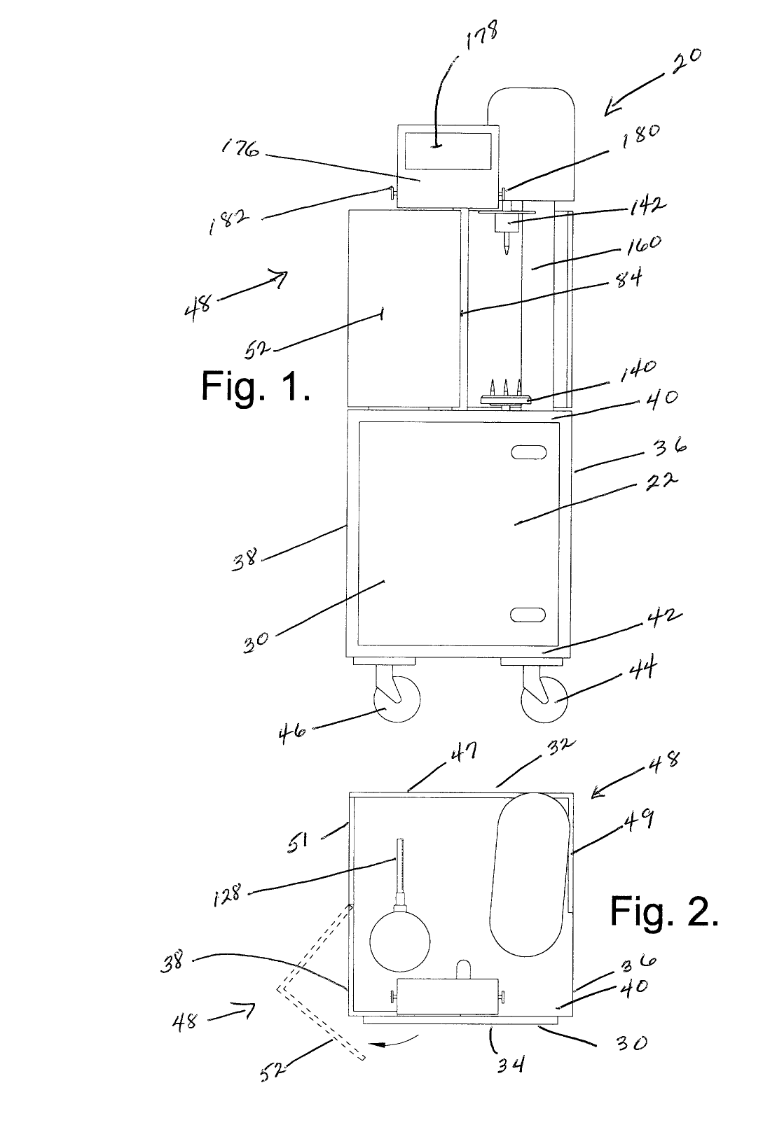

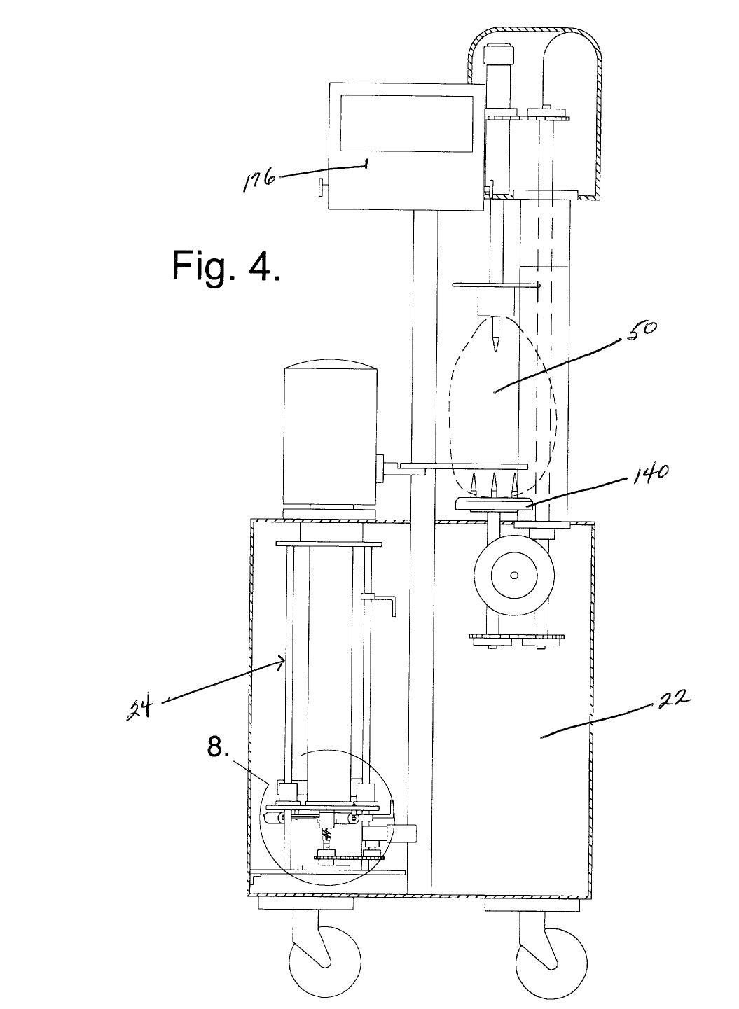

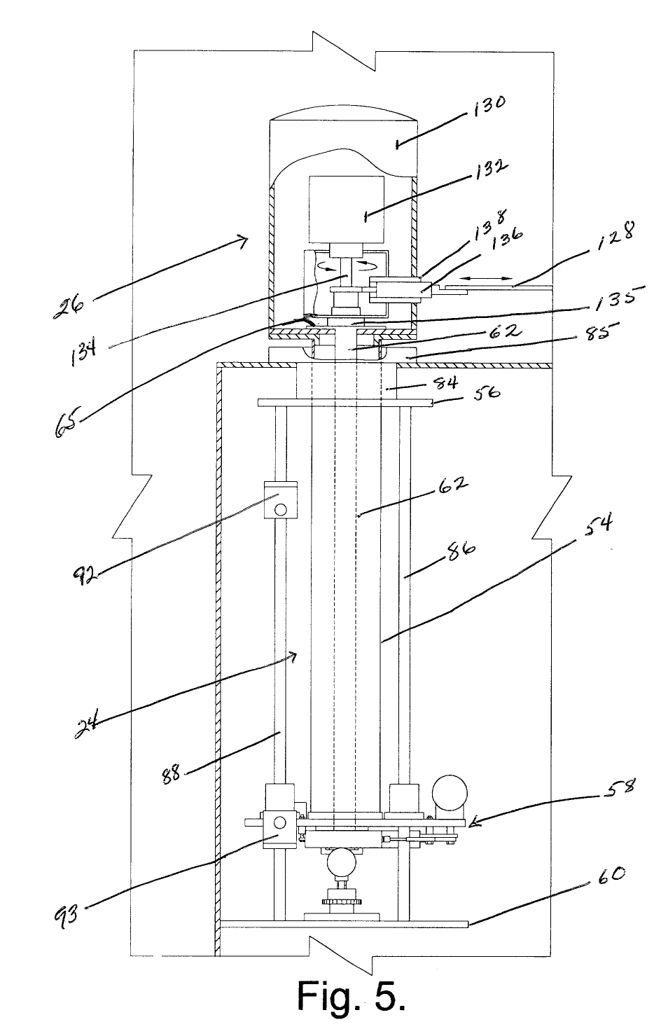

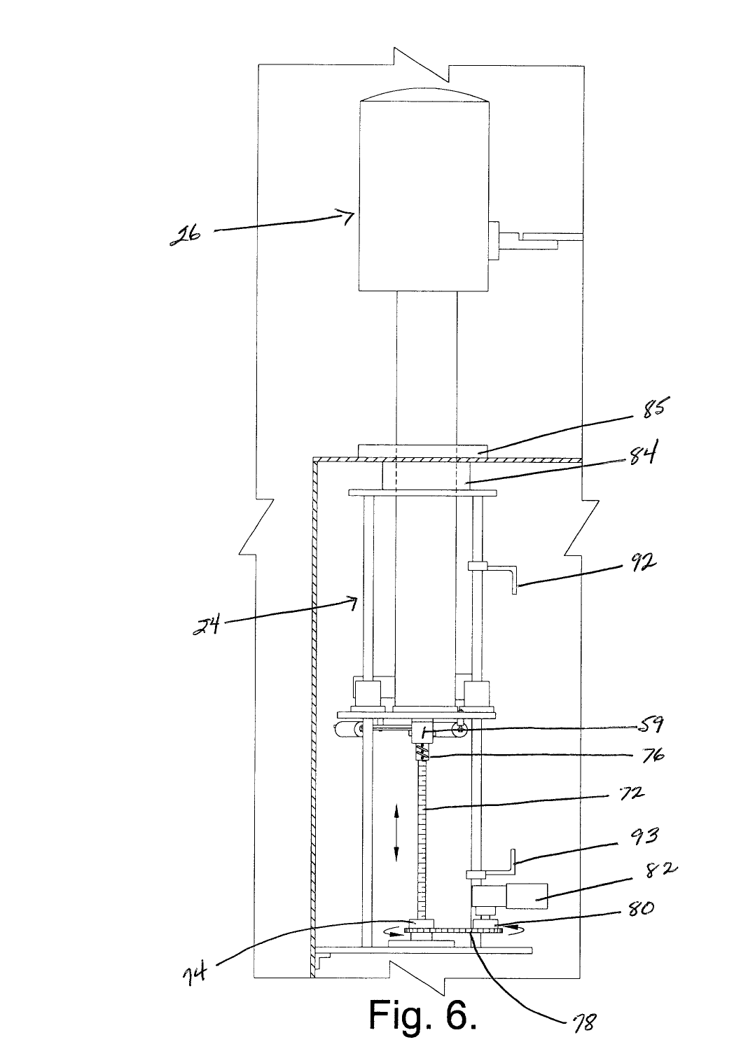

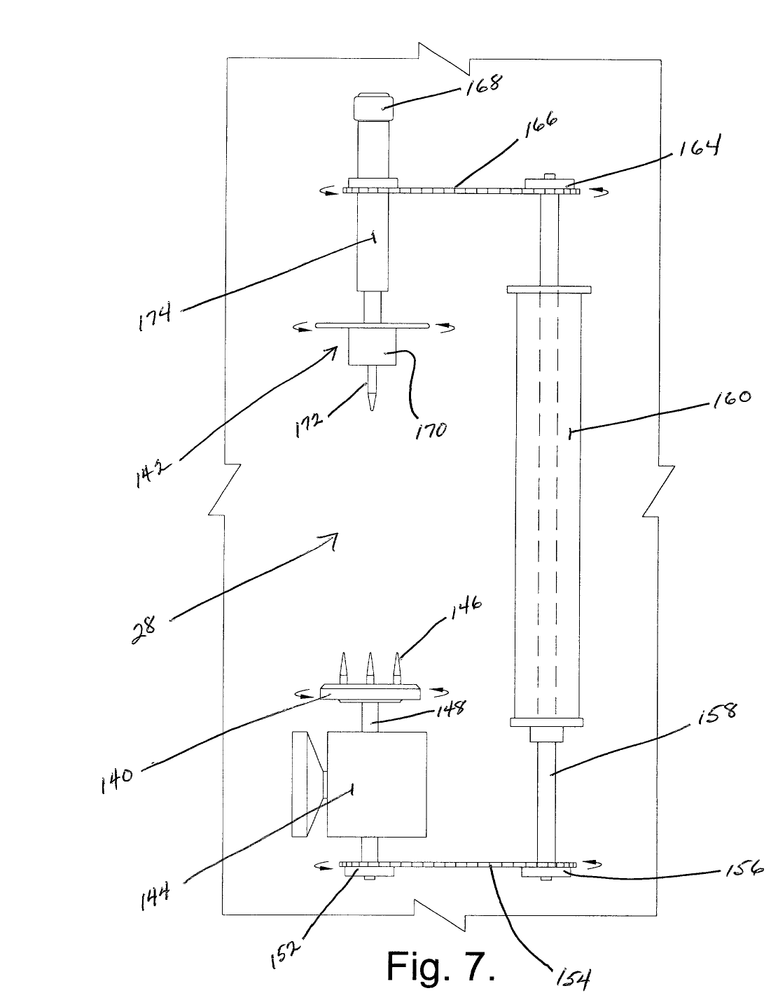

The present invention relates to a device 20 for slicing bulbous meat products, whereby the device has a construction that allows it to be easily cleaned and, thus, comparatively more sanitary. The present device 20 can be used to cut both bone-in and boneless meat products. Any of a variety of meat products can be cut by the present device, including hams, turkeys, and any other bulbous meat products 50. The device 20 has enhanced safety features designed to protect workers from injury and includes a unitary or uni-body cabinet 22 construction, shown in FIGS. 1, 2, 3, and 4. Furthermore, the device 20 has a limited number of exposed parts, which contributes to its suitability for industrial uses. A mast system 24, best shown in FIGS. 5 and 6, is part of the device 20, and is designed to move the knife assembly 26 in a vertical plane. The knife assembly 26 houses and actuates the knife 128 used to cut the meat product, which is best shown in FIG. 5. The meat product is rotated in a clockwise or counterclockwise path during cutting, with the rotation assembly 28, shown in FIG. 7, designed to rotate the meat product. Collectively, the above mentioned assemblies work together to provide for precision cutting of the meat product.

As mentioned, the device 20, also known as a meat slicer, includes a cabinet member 22, which has at least one door 30 hingedly attached thereto. More preferably, the cabinet 22 has two doors located opposite one another. The doors 30 allow for placement of different devices and parts in the cabinet 22, which are to be housed by the cabinet. Also, the doors allow for easy maintenance of the devices and parts housed by the cabinet 22. The cabinet member 22 has a seamless, uni-body construction so that the cabinet member is of a unitary construction, except for the doors. The doors 30 are sealingly connected to the cabinet 22 so as to prevent scrap material from becoming lodged between the cabinet and the doors. The seal more importantly prevents water from contacting the internal components during cleaning. It is preferred that there be no seams between the sidewalls, or the top and bottom of the cabinet. This is advantageous because there are no crevices or small spaces on the cabinet 22 in which blood or small meat particles can be lodged. The uni-body construction makes the cabinet 22 easy to clean, which facilitates thorough sanitation, and prevents the growth and proliferation of bacteria and parasites. As such, the cabinet 22 has a generally square construction. Because of the square construction, the cabinet has two sets of opposed sides 32, 34, 36 and 38, shown in FIG. 2. The cabinet has a top 40 and a bottom 42, with the top 40 having a plurality of holes designed to allow for passage of part of the mast assembly 24 and members of the rotation assembly 28. The holes having the various assemblies passing therethrough will be sealed in such a way as to prevent bits of meat and waste products from lodging in and around the holes or leaking into the cabinet.

Located on the bottom of the cabinet will be wheel members, or casters 44 and 46, which allow for the device 20 to be readily moved. Any of a variety of members for making the cabinet mobile may be used, with the wheels 44 and 46 preferred. The cabinet 22 is made of aluminum, stainless steel, or any other similar material that can be easily cleaned and is suitable for commercial meat plant sanitation procedures. The dimensions of the cabinet are generally 2.5 feet in length by 3 feet in width by 2.5 feet in height. The dimensions are, in part, determined by the size of the various components. Such size is preferred, as this allows for various parts and members which form the device 20 to be at least partially housed by the cabinet 22. This is important to limit the number of exposed parts. Various other sizes, shapes, and constructions can be used to form the cabinet. The cabinet must be generally seamless, hold the various parts, and be of a size to allow various meat products to be cut.

Attached to, or near, the top surface 40 of the cabinet 22 will be a shroud member 48, as shown in FIGS. 1 and 2. The shroud member 48 forms a protective barrier that substantially encircles the knife assembly 26 and the meat product 50. This limits workers from readily contacting the meat product 50 during cutting. The shroud member 48 is designed to have a hinged door 52 or wall member that opens and closes, so that the device can be more easily cleaned and parts can be accessed for maintenance. The door does not have to be opened to remove or place a meat product 50 on the turntable 140. The shroud 48, however, does provide less access or exposure to the knife assembly 26 than would otherwise exist. The shroud 48 is a safety device intended to prevent workers from getting their hands and arms near the knife member during operation of the device 20. Importantly, the device 20 cannot be easily activated, unless a worker is shielded from the knife 128 by the shroud. A sensor connected to the computer control system or, more specifically, a microprocessor, can be included on or around the shroud. The sensor will prevent operation of the device 20 when the shroud 48 is open; in particular, it will prevent the knife from cutting. The shroud member 48 is preferably permanently affixed to the cabinet 22, with a small space between the top surface 40 of the cabinet and the bottom of the shroud, as shown in FIG. 1. Alternatively, the shroud 48 can be removably attached to the cabinet. The resultant space between the shroud and cabinet allows for scrap meat byproducts and other contaminants to be easily washed away. The shroud preferably has two permanently affixed walls 47 and 49, which form an L-shape and a second L-shaped wall hingedly attached thereto. Alternatively, the shroud can have three permanently affixed walls 47, 49, and 51, which form a U-shape, and a second L-shaped wall hingedly attached thereto, as shown in FIG. 2. The shroud door 52 is best shown in FIG. 2. The shroud is erected around the outside edge of the cabinet and has a height equal to about two feet.

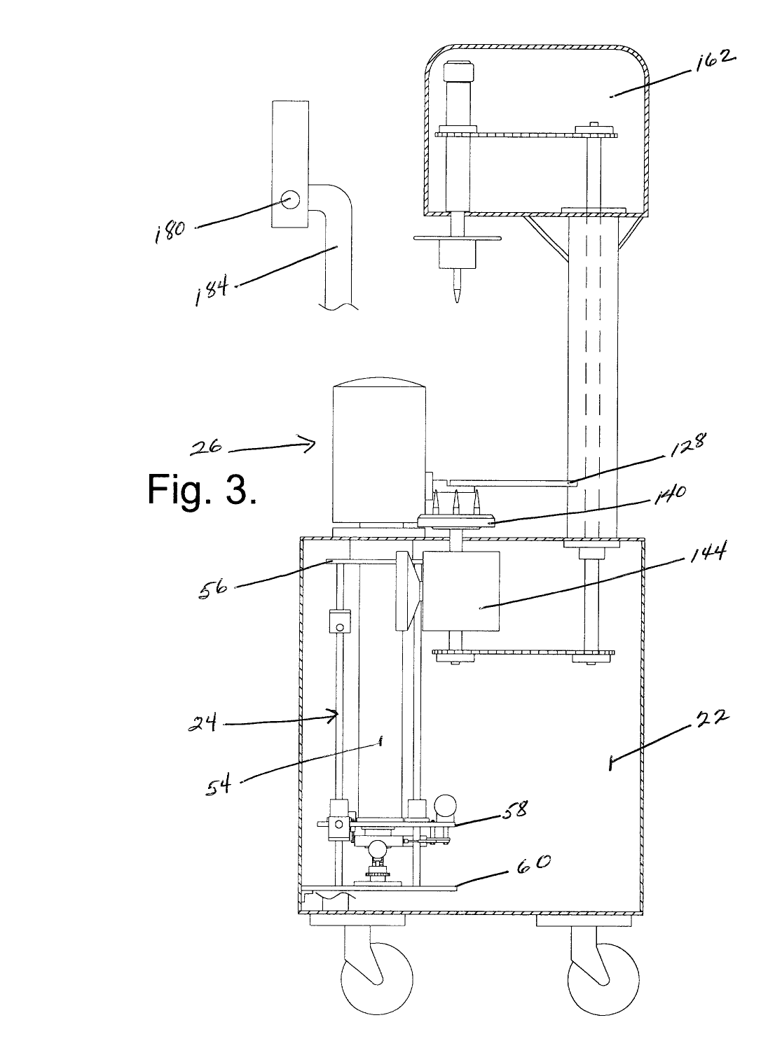

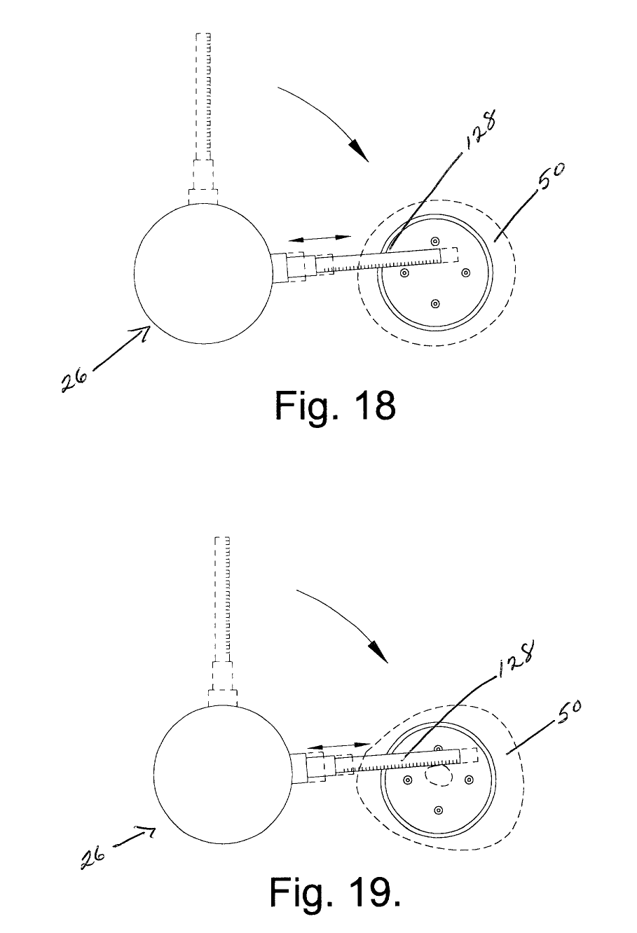

The mast assembly 24, is best shown in FIGS. 3-6, and is located primarily in the cabinet 22. The mast assembly 24 passes through a hole in the top surface 40 of the cabinet 22 to move the knife assembly 26 up and down in a vertical plane. The upward movement of the mast assembly 24 is best shown in FIG. 6. The mast assembly 24 is also designed to actuate movement of the knife assembly 26 in a horizontal plane, with such movement best illustrated by FIGS. 18 and 19. As a meat product is being cut, the mast assembly 24 moves the knife assembly 26 in and out of the meat product 50 and upward during cutting. Once cutting is complete, the knife assembly 26, in particular, the knife 128, is rotated out of the product 50, and the mast assembly 24 will move downward to reposition the knife assembly 26 for cutting a new, uncut meat product 50. As such, the mast assembly 24 pushes the knife 128 into position for cutting of the meat product 50, and moves it upward as the meat product is rotated during cutting. The mast assembly 24 includes a mast tube 54, a top plate 56, a bottom plate 58, and a base plate 60.

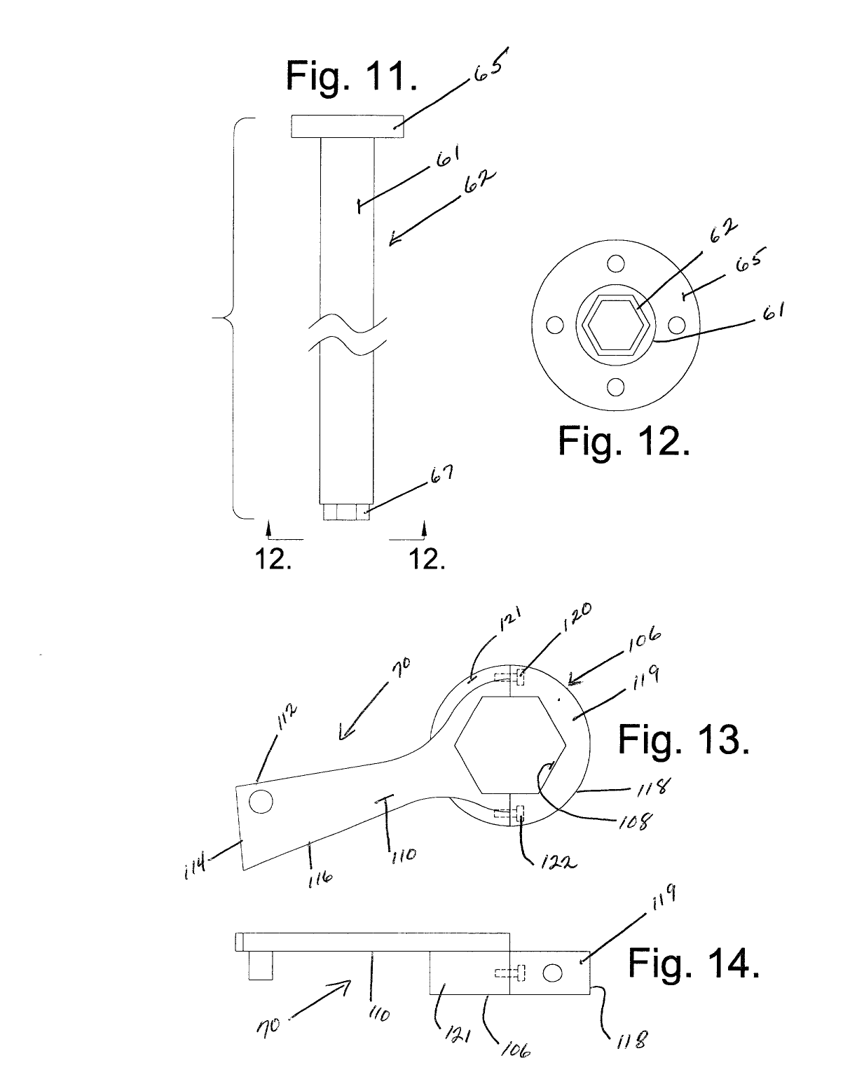

The mast tube 54, is best shown in FIGS. 5, 8, 9, 11, and 12, and can be moved vertically to, in turn, cause the knife assembly 26 to move vertically, up or down, as shown in FIG. 6. The mast tube 54 preferably is a tube having a cylindrical construction; however, other designs may be used, as long as the tube 54 can be moved vertically. Other designs could include triangular or rectangular shapes, for example. The mast tube 54 is fixedly or removably attached on one end to the base 135 of the knife assembly 26. On an opposite end, the mast tube is fixedly attached to the bottom plate 58. The mast tube 54 is preferably between two feet and three feet long, with the diameter of the mast tube 54 preferably ranging between 4 inches and 18 inches. The mast tube 54 provides means by which the knife assembly 76 can be moved vertically by a motor located in the cabinet. Other means or parts which allow for vertical movement of the knife assembly may be used.

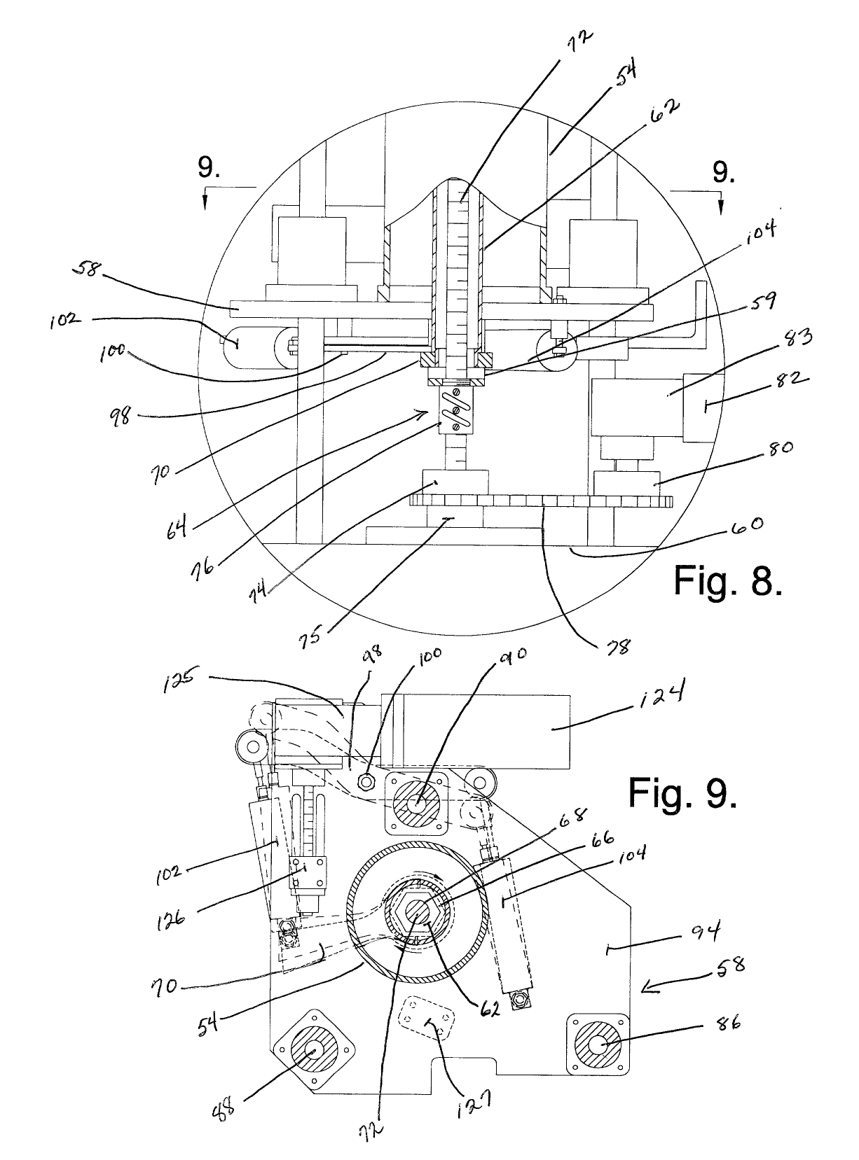

Located inside the mast tube 54 is a hex head tube 62, shown in FIGS. 8, 11, and 12, which is attached on one end to the bottom plate 58 by the actuating arm 70, and on the other end to the knife assembly 26 shown in FIG. 5. The hex head tube 62 is designed to move the knife assembly 26 horizontally. In particular, the hex head tube 62 is designed to translate horizontal movements from components housed in the cabinet to the knife assembly 26 located outside the cabinet 22. The hex head tube 62 will move in conjunction with the mast tube 54 as the ball screw assembly 64 moves up or down. As such, the hex head tube 62 moves vertically, up or down. The hex head tube 62 has a tubular member 61, with a hexagonal head 67 integrally attached to the bottom of the tubular member 61. Opposite the hexagonal head 67, attached to the tubular member 61, is an annular flange member 65. The tubular member 61 is of an annular construction. The hexagonal head 67 is, preferably, of a six-sided outer wall 66 construction and an annular inner wall 68. While six sides are preferred, any outer wall construction, including an annular construction, can be used to form the outer wall 66 of the head 67. The hexagonal shape of the outer wall 66 of the hexagonal head 67 is preferred because an actuating arm 70, shown in FIGS. 13 and 14, is removably attached to the hex head tube 62. If the outer wall 66 is annular in shape when the arm 70 rotates the hex head tube 62, there may be some slippage during rotation. The hexagonal shape of the hexagonal head 67 and the arm 70 prevents the actuating arm 70 from slipping when it is actuated to cause rotation of the hex head tube 62. The hex head tube 62 will have a length ranging between two (2) and three (3) feet. The inner diameter of the hex head tube 62 is such that the ball screw 72 of the ball screw assembly 64 is located within the inner diameter of the hex head tube. Generally, the inner diameter of the hex head tube 62 will range between 1 inch and 3 inches.

As mentioned, the hex head tube 62 is attached to the knife assembly 26, which is shown in FIG. 5. When the hex head tube 26 is actuated by the actuating arm 70, it causes the knife assembly 26 to rotate horizontally. The hex head tube 62 has an annular flange member 65, which is fixedly attached to the base 135 of the knife assembly and the knife assembly housing 130. The hex head tube 62 will horizontally move both the knife and the knife housing. As such, the hex head tube provides means by which air cylinders 102 and 104, located in the cabinet 22 can cause horizontal movement of the knife assembly 26. In particular, the hex head tube is used to rotate the knife assembly into a cutting position. Also, the hex head tube 62 is part of the means that translates air pressure from a dual pneumatic system to the knife, by allowing the knife to lightly contact a bone in the meat product. The air pressure can be varied according to the particular situation. Air cylinders 102 and 104 partially comprise the dual pneumatic system and, resultantly, apply partial, controlled pressure to the meat product 50. The air cylinders also turn the knife in and out of the meat product. Movement of the actuating arm 70 is facilitated by the air cylinders 102 and 104, whereby, when the actuating arm is moved, the actuating arm 70 is actuated to cause the hex head tube 62 to rotate, which, in turn, causes movement of the knife assembly 26 and, in particular, the knife 128, in a horizontal plane.

Located inside the hex head tube 62 is the ball screw 72, which is part of the ball screw assembly 64. The ball screw 72 will remain vertically stationary and is rotatably affixed to the bearing housing 75 attached to the base plate 60. A sprocket 74, which rotates the ball screw 72, is attached thereto. On an opposite end, the ball screw 72 terminates near the top plate 56. A ball nut 76 is engaged to the ball screw 72, so that the ball nut 76 moves vertically, relative to the ball screw when the ball screw rotates. This, in turn, pushes the hex head tube 62 and bottom plate 58. The ball nut 76 will contact the bottom plate support 59, which is preferably a U-shaped member, affixed to the bottom plate 58. As the ball nut 76 moves upward, the support 59 is pushed, which moves the bottom plate 58 to cause the mast tube 54 and bottom plate 58 to be moved vertically. Thus, the ball screw 72 will cause the ball nut 76 to push the bottom plate support member 59 to cause the assembly to move upward. As mentioned, the ball screw 72 is attached to the sprocket 74, which is, in turn, attached to a chain 78. The chain 78 is affixed on one end to the sprocket 74 and on an opposite end to a sprocket 80, which is actuated by a motor 82. A gear box 83 is attached to the motor. A motor and a dual sprocket assembly are the preferred means for moving the ball nut vertically. As the chain 78 is actuated, the ball screw 72 rotates causing movement of the mast 54 and the bottom plate 58 via the ball nut. The ball screw assembly 64 is rotatably attached to the base plate 60, and is the means by which the mast tube is moved vertically.

The ball screw assembly 64 is preferred because it allows for precise movement which, in turn, allows for the meat product to be precisely cut. Thus, use of the present ball screw assembly 64 is preferred because it provides for precise vertical movement of the knife assembly. Any of a variety of means and devices, however, can be used to ultimately move the knife assembly 26 in both vertical and horizontal planes. Any of a variety of screw members that can actuate movement up or down can be used in the present invention. An example of a preferred ball screw assembly is made by Thompson Saginaw.

The top plate 56 is affixed to a cylinder support block 84, which permits passage of the mast tube 54 and movement of the mast assembly 24 in a vertical plane. The top plate 56 abuts the cylinder support block 84, which passes through the cabinet 22. The cylinder support block 84 is contacted by the base of the knife assembly 26. The cylinder support block includes an annular flange 85, which abuts the top 40 of the cabinet. A seal is formed between the support block 84 and the top 40 of the cabinet 22, through which the mast tube passes.

The top plate 56 also is attached to at least two 86 and 88 guide shafts, and preferably three 86, 88, and 90 guide shafts, with the top plate 56 fixedly attached to and maintaining the position of the guide shafts. The guide shafts 86, 88, and 90, best shown in FIGS. 5 and 9, extend downward from the top plate 56 to the base plate 60. The bottom plate 58 is designed and dimensioned to slideably move on the guide shafts, which are stationary. The guide shafts 86, 88, and 90, are designed to prevent extraneous movement of the bottom plate. The guide shafts will have a length ranging between 2 feet and 3 feet, and a circumference of about 1 inch. Located on at least one of the guide shafts 86, 88, or 90 will be a proximity switch 92, or sensor, or similar member. The device 92 is designed to signal the computer controls or microprocessor of the device 20. The sensor prevents the continued upward movement of the bottom plate, and the malfunction of the device. An additional sensor 93 can be included near the base plate 60 to limit downward movement.

The base plate 60 is located in the cabinet 22 opposite the top plate 56, and is affixed at a position near the bottom of the cabinet. The base plate 60 can be affixed to the base 42 of the cabinet or at a position slightly above the base. The base plate 60 is designed to support the guide shafts 86, 88, and 90 and the ball screw 72. Also, attached to the base plate is the bearing housing 75.

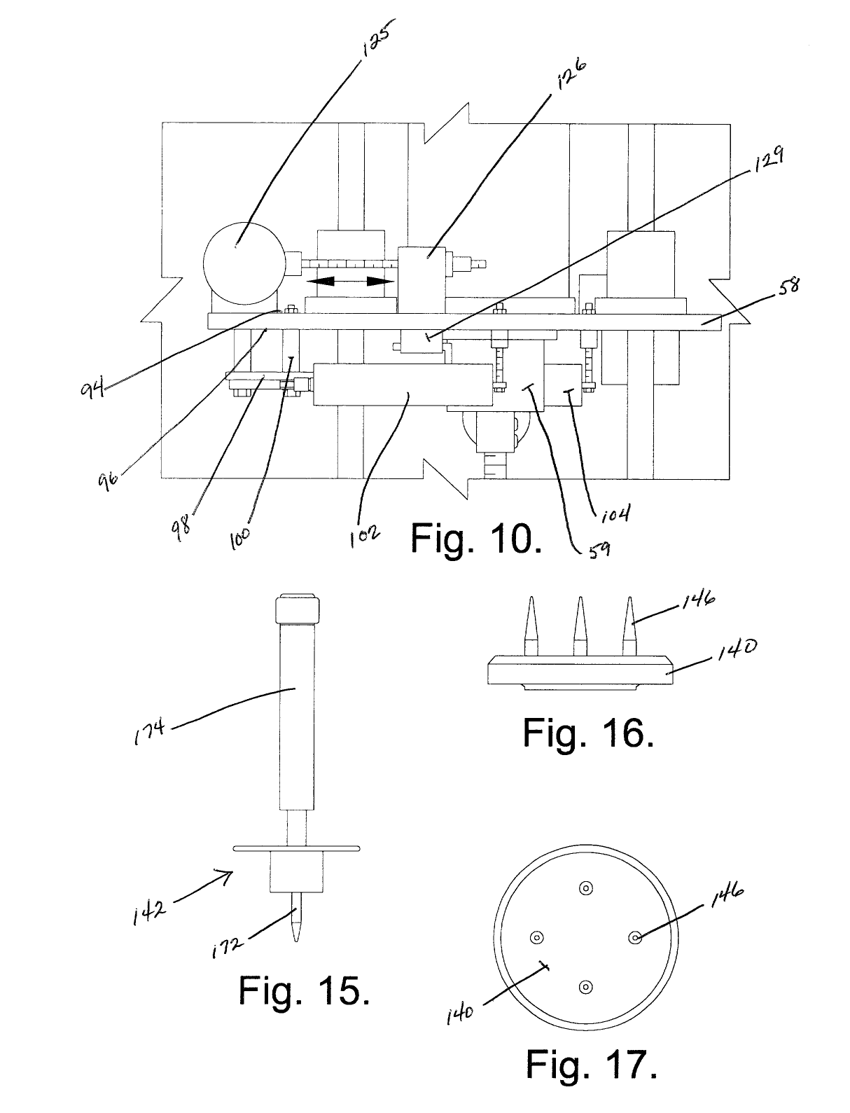

The bottom plate 58 is best shown in FIGS. 8, 9, and 10. The bottom plate 58 has a top face 94 and a bottom face 96 and moves in conjunction with the mast assembly 24. As mentioned, the bottom plate 58 is mounted on the guide shafts 86, 88, and 90, to inhibit horizontal and, especially, extraneous movement of the plate. The mast tube 54 and the hex head tube 62 are received by, and move in conjunction with, the plate 58, with the ball screw 72 passing therethrough. The bottom plate is any of a variety of shapes. It is preferably of a design to hold the below listed components.

Attached to the bottom face 96 of the bottom plate 58 is a pivot arm 98, which rotates on a pivot point 100. Attached to opposite ends of the pivot arm 98 will be a pair of air cylinder members 102 and 104. The air cylinders 102 and 104 are primary components, along with the hex head tube 62 and pivot arm 98 of the pneumatic system, for maintaining knife contact with the bone of a bone-in meat product.

The air cylinders 102 and 104 are important to cause the knife to ride against the bone of a bulbous meat product having a bone located throughout. Typically, the air cylinders 102 and 104 will maintain sufficient air pressure to control the cutting pressure of the knife against the bone. For example, the pressure can be about 20 psi. As mentioned, other pressures can be selected. The air cylinders 102 and 104 also rotate the knife in and out of the meat product.

The pivot arm 98 preferably has a flattened S-shape. However, other shapes may be used, as long as the air cylinders 102 and 104 can be used to translate controlled pressure onto the actuating arm 70 and, resultingly, the hex head tube 62. One air cylinder 104 is attached to the bottom plate on an end opposite the pivot arm 98. The other air cylinder 102 is movably attached to the actuating arm 70 on an end opposite the pivot arm 98. The air cylinders 102 and 104 are attached to the actuating arm 70 and bottom plate 58, respectively, by a bolt, or similar member. The pivot arm 98 will move on the pivot point 100 so that the motion is translated from the air cylinders 102 and 104 to cause the actuating arm 70 to move and, in turn, rotate the hex head tube 62, as shown in FIG. 9. All of the above constituents, along with the microprocessor, form the pneumatic knife system. Other systems, which permit the knife 128 to contact a bone in a meat product without chipping the bone, can be substituted herefor. Additionally, other systems which can be used to move the knife assembly horizontally may be used.

The actuating arm 70, shown in FIGS. 13 and 14, has a collar 106 that can be fastened around the hexagonal head 67, with the collar having an inside face 108, wherein such construction is of the same shape as the hexagonal head 67. If the hex head tube 62 has a hexagonal outside wall, then the inside face 108 of the collar 106 will be of a hexagonal construction. Integral with the collar will be a leg member 110. The leg 110 has three different edges, which include a top edge 112, back edge 114, and bottom edge 116. The top edge 112 is positioned at an angle such that it will contact the pivot stop 126 flush. The back edge is shown as 114. The bottom edge 116 is at angle designed so the bottom edge 116 contacts the stop member129 flush. The construction of the leg 110 is designed to ensure the actuating arm 70 contacts evenly the pivot stop 126 and the arm stop 127 evenly. The outside edge 118 of the collar is substantially circular. The collar 106 has two halves 119 and 121. The collar 106 has two removable bolts, 120 and 122, which can be tightened and loosened to tighten and loosen the collar. This is to ensure a firm fit around the hex head tube, in particular, the hexagonal head 67, and to allow easier placement on the hex head. The collar 106 is preferred; however, other means can be used to translate controlled pressure from the air cylinders 102 and 104 to the hex head tube, which in turn applies light pressure to the knife 128 while it cuts against the bone of a meat product. It should further be noted that the leg member 110 must be positioned relative to the collar 106 such that the knife is rotated within a plane that allows the meat product to be cut. The position must be such that the knife can be moved in and out of the meat product appropriately.

The motor 124 and gear box 125 are located on the top face 94 of the bottom plate 58, is attached to a pivot stop 126, which is used to determine the maximum rotary travel of the actuating arm 70. The motor 124 moves the pivot stop 126 back and forth to change the maximum potential distance of travel of the actuating arm 70. The pivot stop is typically set at a position whereby the knife would rotate beyond the center of the bone-in meat product.

The pivot stop 126 determines maximum movement of the actuating arm 70 during cutting of the meat product. The pivot stop 126 is located on the top face of the bottom plate, with a stop member 129 passing through the bottom plate 58 to a location near the bottom face 96. This allows the pivot stop 126, in particular the stop member 129, to be positioned to be contacted by the actuating arm 70 to limit maximum travel of the arm. The pivot stop 126 is also used to cut a product that is boneless. The pivot stop moves into position to be adjusted in such a way to limit the maximum cut depth of the knife in the meat product. Thus, the air cylinders push the actuating arm 70 to resultantly turn the hex head tube 62 and, consequently, the knife, into the meat product. The knife is located at a position that will leave a meat core or plug during cutting. Located on the plate opposite the pivot stop will be a shock absorber or arm stop 127.

The knife assembly 26 is designed to be moved both in a horizontal and vertical plane. The knife assembly is rotated into position, horizontally, shown in FIGS. 18 and 19, to cut the meat product 50, and then is pushed vertically, shown in FIG. 6, while the meat product rotates to cut or slice the meat product. Additionally, the knife assembly 26 will have a knife 128, shown in FIG. 5, which will have a reciprocating motion to cut the meat product by means of a back and forth slicing action. Alternatively, a rotary blade or other cutting device can be used in place of the knife 128.

The knife assembly 26, as shown in FIG. 5, includes a housing member 130, which is connected on a bottom end to the mast tube 54, with the knife assembly housing rotating relative to the mast tube. The hex head tube 62 is connected to the knife assembly so that when the hex head tube rotates, the knife assembly rotates therewith. Specifically, the hex head tube upper plate or annular flange 65 is attached to the base 135 of the knife assembly. The mast tube 54 and hex head tube 62 pass through the cylinder support block 84, which is affixed to the top surface of the cabinet. The support block 84 is typically a flanged cylinder and forms a seal so that contaminants are prevented from collecting between the knife assembly 26 and the cabinet 22. Located within the knife assembly housing 130 will be a motor 132 for actuating the reciprocating movement of the knife 128. The motor 132 is attached to a cam mechanism assembly 134 to cause the knife to reciprocate. A reciprocating rod 136 is attached on one end to a knife and on an opposite end to the cam assembly 134. The reciprocating rod 136 is positioned and sealed within a reciprocating rod bearing housing 138. The reciprocating rod 136 will move in and out of a rod-bearing housing member 138 that is sealed to prevent contamination. The knife 128 is removably attached to the reciprocating rod so that new blades can be swapped in and out. The hex head tube will extend into or attach to the bottom of the knife housing and be attached to the knife assembly to cause the horizontal movement of the knife.

The rotation assembly 28 is designed to rotate the meat product 50 synchronously at the top and the bottom. When the meat product is put into position and held by the turntable 140 and tail stock 142, the turntable 140 and tail stock 142 will turn together during the cutting process. Any of a variety of means and devices can be used to turn the tailstock 142 and turntable 140. Two separate motors could be used, or a single motor that powers both the tailstock 142 and turntable 140 can be used. It is preferred, for cost reasons, to use a single motor assembly 144. The assembly 144 includes a gear box and motor.

Preferably, the turntable 140, shown in FIGS. 7, 16, and 17, will have a plurality of spikes 176, which skewer the meat product and hold it in place. The turntable 140 is attached to a motor 144 by a shaft member 148. The shaft 148 passes through the cabinet 22 and has a sealed relationship to prevent contamination. The shaft 148 will rotate the turntable member, and project up through the cabinet so that the turntable 140 is located proximal to the top surface 40 of the cabinet 22.

In the preferred construction, the motor assembly 144 will be attached on one end to the shaft 148 to turn the turntable 140, and on an opposite end to a shaft 150, which turns a sprocket 152. The sprocket 152 is attached to a chain 154, which is affixed on the opposite end to a separate sprocket 156. A shaft 158 will extend from the sprocket 156, which is located in the cabinet, through a shaft housing member to an upper shaft assembly housing 162. The shaft 158 is attached to an opposite sprocket 164. Attached to the sprocket 164 is a chain 166, which, in turn, turns the tail stock drive 142, as shown in FIG. 15. Thus, the shaft 158 assists in translating the motion from the motor 144, which is located in the cabinet 22, up to the tail stock drive 142, so that the meat product can be turned synchronously.

The tail stock drive 142 is shown in FIGS. 7 and 15, has an end cap 168, a nose 170, at least two spikes 172, and a tubular member 174. The tube 174, attached to the chain 166, will rotate the nose 170, which, in turn, rotates the spikes 172 placed in the meat product. The housing 160 is added to ensure the sanitary construction of the device 20. The housing 160 forms a sealed relationship with the surface 40 and the upper shaft assembly housing 162. This prevents meat and scraps from lodging between the housing 60 and the cabinet 22. The tail stock drive can be moved into position to skewer the meat product. This can be accomplished by pneumatic, manual, or mechanical means.

The tail stock drive 142 includes a sensor, which essentially determines the location of the tail stock once it is moved into position in the meat product and then allows the calculation of the relationship between the spikes and the height of the product. The microprocessor will infer the height of the meat product. The sensor can be an electronic eye, sonic sensor, linear potentiameter or any of a variety of other sensors. The sensor is designed to determine the height of the product and, through computer controls, the cut height.

The computer control system is located in a computer housing 176. The housing includes a read-out screen 178, operator interface, and a small computer, more preferably a microprocessor. The microprocessor will have the speed of rotation of the rotation assembly entered by the operator, as well as the determination of how close to cut near the spikes, and the cut thickness. As a result of the input information and sensory information the microprocessor will control the location of the knife assembly and mast assembly, and the cut height in particular the relationship of the spikes to the height of the product. Also, the recripricating speed of the knife will be entered. All of this is done to ensure consistent and accurate cutting of the meat product. The computer control assembly will also monitor the shroud 48 to ensure that it has been shut so as to prevent injury to workers. Included in the housing 176 for the computer control assembly will be a pair of buttons 180 and 182, which have to be activated simultaneously in order to turn on the slicing of the machine. If the buttons 180 and 182 are not simultaneously touched, the slicing will not occur. The housing is placed above surface 40 in an elevated position, with the housing connected to the cabinet 22 by housing tube 184.

The resultant meat product can be a bone-in or a boneless product. The slices made in the product can be any of a variety of thicknesses. If a bone-in product is cut, the present device is designed so that the knife can follow the line of the bone, regardless of whether it is curved.

The method of the present invention includes placing a meat product 50 on the turntable 140, followed by moving the chuck 142 into position by skewering the spikes 172 and 146 into the meat product at the top and bottom. The sensor provides information to the microprocessor will then infer the relationship between the spikes and the meat product. Additionally, the operator will have input the desired cut thickness of the meat product, and the turntable speed. Additionally, the operator will have previously adjusted the maximum travel of the knife, which is based on whether the meat product is boneless or bone-in. The device 20 will then be activated whereby the air cylinders 102 and 104 will pneumatically push the actuating arm 70 which will in turn rotate the hex head tube 62 and cause the knife assembly 26 to move horizontally into the meat product 50. The knife assembly 26 will then be pushed upward, while the knife 128 reciprocates back and forth. During the reciprocating cutting, the meat product will rotate in a circular plane. The movements of the assemblies working together in conjunction will result in a meat product that will be precisely cut to a thickness entered as three decimal places. As the knife assembly 26 moves vertically and reaches maximum cut height as entered previously, it will be rotated horizontally away from the meat product and be moved vertically downward to the stationery position. The meat product can then be removed from the device.

Thus, there has been shown and described a product for slicing meat, which fulfills all the objects and advantages sought therefore. It is apparent to those skilled in the art, however, that many changes, variations, modifications, and other uses and applications for the meat slicer are possible, and also such changes, variations, modifications, and other uses and applications which do not depart from the spirit and scope of the invention are deemed to be covered by the invention, which is limited only by the claims which follow.

What is claimed is:

1. A device for slicing a meat product, whereby said device can be maintained in a sanitary condition and is easily cleaned, said device comprising:
(a) a cabinet of a unitary construction;
(b) a knife assembly that can be moved vertically and horizontally, and is located on top of said cabinet, said knife assembly includes a knife that has reciprocating movement;
(c) a mast system attached to said knife assembly and located inside said cabinet, said mast system moves said knife assembly in a vertical direction and controls horizontal movement of said knife assembly;
(d) a microprocessor in a housing assembly and attached to said cabinet; and,
(e) a rotation assembly for holding and rotating the meat product synchronously, said rotation assembly partially housed in said cabinet.

2. The device of claim 1 wherein said cabinet is of a sufficient size to house said mast system and part of said rotation assembly, said cabinet has a top and a bottom integrally connected to each other by two parallel side walls, and has opposed doors which are sealingly connected to said cabinet.

3. The device of claim 1 wherein said knife assembly comprises:
(a) a housing member;
(b) a motor located inside said housing member;
(c) a reciprocating member attached on one end to said motor;
(d) a knife attached to said reciprocating member, whereby said motor actuates the reciprocating movement of said knife.

4. The device of claim 1 wherein said mast system comprises:
(a) a mast tube;
(b) a hex head tube located inside said mast tube;
(c) a ball screw located inside said hex head tube;
(d) a plate member attached to said mast tube opposite said knife assembly;
(e) a pair of air cylinders located on said plate's bottom side, with one said air cylinder attached to an actuating arm which rotates said hex head tube to resultingly turn said knife assembly in a horizontal plane; and,
(f) a ball nut engaged to said ball screw, with said nut moving in a vertical plane relative to said ball screw, said ball nut will resultingly move said mast system vertically.

5. The device of claim 1 wherein said rotation member comprises:
(a) a turntable having a plurality of spikes; and,
(b) a tail stock drive having at least two spikes whereby said turntable and tail stock turn synchronously when a meat product is turned thereon.

6. The device of claim 1, wherein said device has a shroud member attached to said cabinet.

7. The device of claim 1, wherein said device comprises a plurality of sensors connected to said microprocessor, whereby data can be input to precisely control cutting of the meat product.

8. The device of claim 5, wherein said rotation member comprises a housing member, which sealingly connects said tail stock drive to a motor found in said cabinet.

9. The device of claim 1 wherein said computer housing assembly has two buttons which must be simultaneously pushed to activate said device.

10. A device for slicing a meat product, whereby said device facilitates thorough sanitation and is easily cleaned, said device comprising:
(a) a cabinet of a unitary construction;
(b) means for moving a knife assembly vertically and horizontally;
(c) a microprocessor control system connected to at least two sensors, which allow for control over slicing speed, turning speed of the meat product, and thickness of cut; and,
(d) a rotation assembly for holding and rotating the meat product synchronously.

11. A device for slicing a meat product, whereby said device can be maintained in a sanitary condition and is easily cleaned, said device comprising:
(a) a cabinet of a unitary construction;
(b) a knife assembly that can be moved vertically and horizontally, and is located on top of said cabinet, said knife assembly includes a knife that has reciprocating movement;
(c) a mast system attached to said knife assembly and located inside said cabinet, said mast system moves said knife assembly in a vertical direction and controls horizontal movement of said knife assembly;
(d) a microprocessor in a housing assembly and attached to said cabinet; and,
(e) a rotation assembly for holding and rotating the meat product synchronously, said rotation assembly partially housed in said cabinet.
